(19) United States
(12) Patent Application Publication
(10) Pub. No.: US 2007/0171563 A1
(43) Pub. Date: Jul. 26, 2007

(54) System and method for adjusting pressure sensitivity in sealed disk drive to account for temperature-induced changes in fly height

(76) Inventor: Remmelt Pit, Palo Alto, CA (US)

Correspondence Address: ROGITZ & ASSOCIATES, 750 B STREET, SUITE 3120, SAN DIEGO, CA, 92101, US

(21) Appl. No.: 11/339,347

(22) Filed: Jan. 25, 2006

(51) Int. Cl. G11B 21/02

(52) U.S. Cl. 360/75

(57) ABSTRACT

The pressure sensitivity of an ABS in a sealed drive is established such that a change in head-disk clearance due to temperature changes inside the drive housing is balanced by clearance changes due to the resulting pressure change. In this manner, the clearance between the head and disk is made insensitive to temperature changes.

### I. FIELD OF THE INVENTION

The present invention generally relates to disk drives such as magnetic hard disk drives.

### II. Background

In magnetic disk drives, data is written and read by magnetic transducers called “heads” which together with supporting structure are colloquially referred to as “sliders”. The magnetic disks are rotated at high speeds, producing a thin layer of air between a disk and a slider that is called an air bearing surface (ABS). The sliders are supported over the rotating disk by the ABS, where they either induce or detect flux on the magnetic disk, thereby either writing or reading data. The distance between the slider and disk is referred to as the “fly height” (FH) and as can be appreciated is a critical dimension. Among other things, design FH has decreased to very small dimensions to facilitate greater data storage density, making for very tight tolerances in the FH to ensure that the slider is sufficiently close to the disk but that it does not touch the disk, which could be very damaging.

The FH in HDDs is sensitive to pressure and temperature in the drive. When the pressure drops, FH typically decreases, and when the pressure increases, FH typically increases. Typically, the FH has been found to drop by as much as four nanometers (in older ABS designs) and, in newer designs, by a half of a nanometer when pressure is reduced from one atmosphere to the atmospheric pressure at 3,000 feet, as might happen when gaining altitude. This is a significant problem for reliability because head-disk clearance is reduced. To eliminate the effects of pressure changes external to the drive, sealed drives have been provided. Another benefit of sealed drives is the ability to dispose the drive in a gas such as Helium, as opposed to air, to reduce flutter caused by air flow and turbulence.

The effect of temperature, as understood herein, is slightly more complicated. At some nominal temperature the surface of the head facing the disk is coplanar with the shields and other slider structure, so that the clearance between the head and disk effectively equals the fly height of the slider. When temperature increases above the nominal temperature, however, the head or heads can protrude toward the disk, beyond the surface of the remaining slider structure such as the shields, owing to differences in thermal expansion coefficients between, e.g., the material of the head and the material of the shields. Thus, increases in temperature result in decreased clearance between the head and disk. The decreased clearance is only partially offset by a slight increase in slider fly height that results from increased pressure in the (now) narrower clearance space between the head and disk. The net effect is that as temperature rises, the head moves closer to the disk, and as temperature falls, the head retracts back away from the disk.

Thus, the head-disk clearance is sensitive to the surrounding temperature because various parts of the drive have thermal expansion coefficients that are different from the thermal expansion coefficient of the head. The consequent (net) effect on head-disk clearance is typically around three nanometers in older head designs, and one nanometer in more advanced designs, for a given departure of temperature from a nominal temperature. In some drives the element spacing change is typically 0.7 nm loss per 10 degrees Celsius change.

For completeness it might be noted here that a “cooling” effect can be produced when a slider flies over a disk which modifies the temperature protrusion slightly compared to measuring in the lab by stylus or optical methods. The cooling effect is due to different pressures and air flow convecting and conducting heat over different parts of the sliders and head structure.

In any case, as recognized herein, because temperature changes in a fixed volume cause pressure changes, a counterbalancing effect can be produced that can be exploited to manage head-disk clearance variations.

### SUMMARY OF THE INVENTION

A method requires establishing a pressure sensitivity of an air bearing surface (ABS) (and more generally of the head gimbal assembly (HGA)) of a sealed disk drive such that a change in clearance between a head and a disk due to a temperature change inside the drive is balanced by a change in the clearance due to a pressure change produced from the temperature change. The change in clearance due to temperature change can be exactly balanced by the change in clearance due to pressure change, so that no net change in clearance occurs, or the change in clearance due to temperature change can be balanced by the change in clearance due to pressure change such that a net clearance at a first, higher temperature is greater than a net clearance at a second, lower temperature.

In non-limiting implementations the change in clearance due to temperature changes is attributable at least in part to at least one thermal expansion coefficient difference. The change in clearance due to temperature changes may be determined by, e.g., using a stylus profilometer and/or an optical interference instrument, and/or by using a read back amplitude and the Wallace Spacing equation.

Yet another alternate method for estimating clearance change due to temperature is to use a heater built into the head structure. By sending current through a resistance, a local heat source near the read/write head causes expansion (protrusion) towards the disk on demand. Typically, up to 100 mW of power can be used to cause about 10 nm of protrusion. Increasing power until contact is detected, the clearance can be estimated at different temperatures to obtain the clearance change as a function of temperature.

In another aspect, the method includes characterizing a clearance between a head of a disk drive and a disk of the disk drive as a function of temperature, and based on the characterization, modifying the sensitivity to pressure of the head gimbal assembly (HGA) of the disk drive.

In still another aspect, a disk drive has a housing, preferably sealed, a disk rotatably disposed in the housing, and a head disposed over the disk for data transfer therewith. The disk drive is configured such that a change in clearance between the head and disk due to temperature change is balanced by a change in clearance between the head and disk due to pressure change.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view of a hard disk drive, showing only one slider and one disk for clarity of exposition;

FIG. 2 is a schematic diagram of a slider with head positioned above a disk at a relatively low temperature, wherein the surface of the head facing the disk is coplanar with the surface of the remaining slider structure;

FIG. 3 is a schematic diagram of a slider with head positioned above a disk at a relatively higher temperature, wherein the surface of the head facing the disk protrudes beyond the surface of the remaining slider structure; and

FIG. 4 is a flow chart of a non-limiting implementation of the present process.

### DETAILED DESCRIPTION OF THE PREFERRED EMBODIMENT

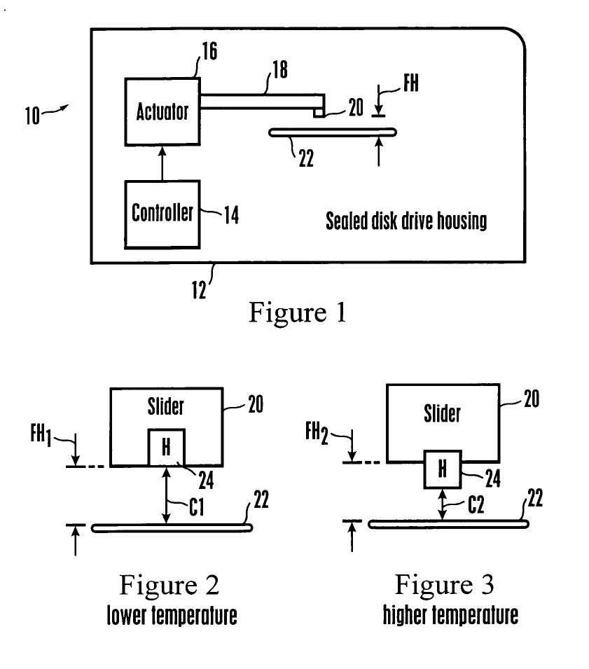

Referring initially to FIG. 1, a disk drive 10, such as a magnetic hard disk drive or optical drive, has a preferably sealed housing 12 such that components within the housing 12 are isolated from pressure changes outside the housing 12. These components can include a controller 14 that controls an actuator 16 such as a voice coil and attendant structure to move an arm 18 as required for data transfer between a slider 20 and a disk 22 that spins on a spindle. The slider 20 can include a read head and write head in accordance with principles known in the art, and a head gimbal assembly (HGA) is established by a combination of the suspension plus gimbal plus slider with ABS surface. Typically, the disk drive 10 includes several sliders and disks. As shown, during operation the distance between the slider 20 and disk 22 establishes a fly height FH.

To illustrate the effect of temperature on disk geometry, as shown in FIG. 2 the slider 20 has one or more heads 24, and the slider with head are positioned above the disk 22. When at a relatively low temperature, the surface of the head 24 that faces the disk 22 is coplanar with the surface of the remaining slider structure as shown. In this geometry, the fly height FH₁ of the surface of the slider 20 that faces the disk 22 is essentially the clearance C1 of the head 24 above the disk 22.

In contrast, as shown in FIG. 3 at a relatively higher temperatures the surface of the head 24 facing the disk protrudes beyond the surface of the remaining slider structure. While the fly height FH₂ at the higher temperature is marginally larger than the fly height FH₁ at the lower temperature geometry of FIG. 2, the clearance C2 between the head and disk is less at the higher temperature illustrated in FIG. 3 than the clearance C1 in the lower temperature geometry shown in FIG. 2.

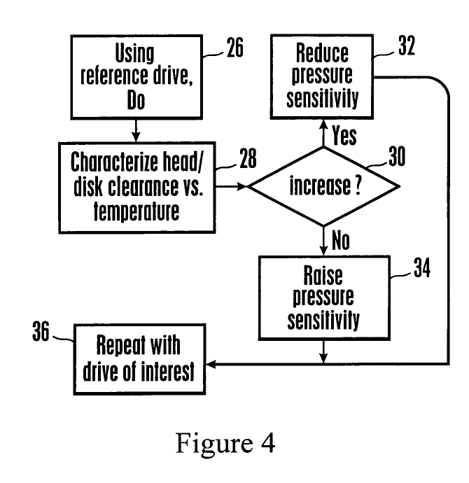

FIG. 4 shows one non-limiting implementation of the present process. At block 26 a reference drive can be used, in which, at block 28, the clearance between the head 24 and disk 22 is characterized. This may done in various ways. By way of non-limiting example, the characterization can be done by, during known ambient temperature changes, measuring a head 24 protrusion profile and amplitude using a stylus profilometer such as an AFM device or using an optical interference device such as a WYKO apparatus. Or, inside a finished drive, read back amplitude can be used to infer spacing change due to temperature, using the Wallace Spacing equation known in the art and ensuring that the change in MR resistance due to temperature is taken into account. Still again, clearance change due to temperature can be estimated by sending current through a heater that is built into the head structure to cause expansion (protrusion) of the head toward the disk. Power is increased until contact is detected, so that the clearance can be estimated at different temperatures to obtain the clearance change as a function of temperature.

Using the measured temperature protrusion, the HGA sensitivity (from another point of view, the ABS sensitivity) to pressure change can be adjusted (using, e.g., ABS computer simulation) to compensate for the temperature protrusion. In other words, if at decision diamond 30 it is noted that the head-disk clearance increases with increasing temperature (usually unlikely), the sensitivity of the HGA/ABS to pressure is reduced at block 32. In contrast, in the more likely event that at decision diamond 30 it is noted that the head-disk clearance decreases with increasing temperature, the sensitivity of the HGA/ABS to pressure is raised at block 34. Once this modelling is complete, at block 36 stages 28-34 are repeated with the drive of interest, it being recognized that in practice, one or more cycles of experiments may be needed to adjust the experimental outcome with the predicted simulations.

To the first order, dT/T=dP/P following the perfect gas law PV=nRT. Typically, the scope of temperature change is on the order of thirty to sixty degrees Kelvin, i.e. dT/T can be on the order of ten to twenty per cent. Consequently, the pressure will change by 0.1-0.2 atmospheres due to temperature changes.

Several ways of adjusting HGA/ABS sensitivity to pressure are known to those of skill in the art, including, without limitation, changing the location of the spring load on the slider that forces the slider toward the disk and changing the load pressure on the trailing edge of the slider.

As contemplated herein, the pressure sensitivity of the head gimbal assembly (HGA), i.e., the combined structure of the suspension, gimbal, slider, and ABS surface, can be established to exactly counterbalance clearance changes due to differences in thermal expansion coefficients, such that the net change in clearance between head and slider in the presence of temperature changes is zero. Alternatively, the pressure sensitivity can be adjusted to overcompensate or undercompensate for temperature protrusion. For example, the pressure sensitivity can be adjusted such that the clearance is marginally higher at a high temperature where the drive might operate most of the time, to improve mechanical reliability, and a little lower at a low temperature (which is less common) to improve magnetic performance at low temperature.

It is to be understood that instead of adjusting the pressure sensitivity directly in terms of head clearance, the head clearance may be indirectly compensated for by using the fly height of the slider minimum position, since, as understood herein, temperature protrusion causes the head to expand towards the disk and at the same time the slider body (“AlTiC” or “N58” in today's products) also expands towards the disk, but with a smaller amplitude (typically one-half of the head protrusion).

While it is expected that pressure sensitivity of the HGA will be adjusted, in less preferred embodiments the pressure sensitivity can remain unchanged and what is in effect the temperature sensitivity of the structure adjusted by, e.g., altering the materials of the slider to achieve differences between thermal expansion coefficients that balance out clearance changes due to pressure.

In addition, increasing the temperature protrusion per degrees Celsius may be desirable in the sense that higher sensitivity can give a better “signal to noise” to facilitate balancing pressure and temperature clearance change. Alternatively, a HGA can be optimized for other parameters, with the result being a relatively high pressure sensitivity. In such a case, to keep the advantages gained on the HGA performance, the temperature protrusion can be increased to match the high pressure sensitivity.

While the particular SYSTEM AND METHOD FOR ADJUSTING PRESSURE SENSITIVITY IN SEALED DISK DRIVE TO ACCOUNT FOR TEMPERATURE-INDUCED CHANGES IN FLY HEIGHT as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method comprising:
establishing a pressure sensitivity of a head gimbal assembly (HGA) of a sealed disk drive such that a change in clearance between a head and a disk due to a temperature change inside the drive is balanced by a change in the clearance due to a pressure change produced from the temperature change.

2. The method of claim 1, comprising determining a first change in the fly height in a sealed disk drive housing caused by a temperature change.

3. The method of claim 2, wherein the first change is attributable at least in part to at least one thermal expansion coefficient difference.

4. The method of claim 2, wherein the first change is determined at least in part using a stylus profilometer and/or an optical interference instrument.

5. The method of claim 2, wherein the first change is determined at least in part using a read back amplitude and the Wallace Spacing equation.

6. The method of claim 1, wherein the change in clearance due to temperature change is exactly balanced by the change in clearance due to pressure change.

7. The method of claim 1, wherein the change in clearance due to temperature change is balanced by the change in clearance due to pressure change such that a net clearance at a first, higher temperature is greater than a net clearance at a second, lower temperature.

8. A method comprising:
characterizing a clearance between a head and/or associated slider of a disk drive and a disk of the disk drive as a function of temperature; and
based on the characterizing act, modifying a sensitivity to pressure of the disk drive.

9. The method of claim 8, wherein the characterizing act is undertaken at least in part using a stylus profilometer and/or an optical interference instrument.

10. The method of claim 8, wherein the characterizing act is undertaken at least in part using a read back amplitude and the Wallace Spacing equation.

11. The method of claim 8, wherein a change in clearance due to temperature change is exactly balanced by a change in clearance due to pressure change, the change in clearance due to pressure change being the outcome of the act of modifying the sensitivity to pressure.

12. The method of claim 8, wherein a change in clearance due to temperature change is balanced by a change in clearance due to pressure change such that the clearance at a first, higher temperature is greater than the clearance at a second, lower temperature, the change in clearance due to pressure change being the outcome of the act of modifying the sensitivity to pressure.

13. A disk drive, comprising:
a housing;
at least one disk rotatably disposed in the housing; and
at least one head disposed over the disk for data transfer therewith, wherein
the disk drive is configured such that a change in clearance between the head and disk due to temperature change is balanced by a change in clearance between the head and disk due to pressure change.

14. The disk drive of claim 13, wherein the housing is sealed such that components inside the housing are isolated from pressure changes outside the housing.

15. The disk drive of claim 14, wherein the disk drive is a hard disk drive.

16. The disk drive of claim 13, wherein the change in clearance due to temperature change is exactly balanced by the change in clearance due to pressure change, whereby no net change of clearance is realized between the head and disk when temperature changes.

17. The disk drive of claim 13, wherein the change in clearance due to temperature change is balanced by the change in clearance due to pressure change such that the net clearance at a first, higher temperature is greater than the net clearance at a second, lower temperature.
